(19) United States
(12) Patent Application Publication
(10) Pub. No.: US 2006/0016284 A1
(43) Pub. Date: Jan. 26, 2006

(54) Ball screw apparatus

(75) Inventor: Masato Kato, Gunma (JP)

Correspondence Address: SUGHRUE MION, PLLC, 2100 PENNSYLVANIA AVENUE, N.W., SUITE 800, WASHINGTON, DC, 20037, US

(73) Assignees: NSK Ltd.; NSK Precision Co. Ltd.

(21) Appl. No.: 11/157,965

(22) Filed: Jun. 22, 2005

(30) Foreign Application Priority Data
Jun. 22, 2004 (JP) P.2004-184191

(51) Int. Cl. F16H 1/24

(52) U.S. Cl. 74/424.88

(57) ABSTRACT

A ball screw apparatus has a screw shaft having a first ball screw groove; a nut including a second ball screw groove oppose to the first ball screw groove, a ball return through hole for circulating the balls and ball turning members having a ball turning passageway communicating with both of the ball load rolling passageway and the ball return through hole and provided at opposite end portions of the nut, respectively; and a number of balls rolling in a ball load rolling passageway formed between the first and second ball screw grooves in accordance with a rotation of the screw shaft or the nut, wherein when a diameter of the balls is represented by Dw, and a diameter of the ball return through hole is represented by D₁, D₁−Dw is 3% of Dw or more and 10% of Dw or less.

The present invention claims foreign priority to Japanese patent application no. 2004-184191, filed on Jun. 22, 2004, the contents of which is incorporated herein by reference.

### BACKGROUND OF THE INVENTION

1. Field of the Invention

This invention relates to an improved ball screw apparatus for converting a rotational motion into a linear motion.

2. Description of the Background Art

A ball screw apparatus, used in a feed mechanism of a machine tool or the like, has a screw shaft, a nut having a ball screw groove which is formed in an inner peripheral surface thereof and is opposed to a ball screw groove formed in an outer peripheral surface of the screw shaft, and a number of balls which roll in a ball load rolling passageway, formed between the ball screw grooves of the nut and the screw shaft, in accordance of the rotation of the screw shaft or the nut.

In such a ball screw apparatus, when the balls are caused to roll along the ball load rolling passageway, for example, by the rotation of the screw shaft, the nut makes a linear motion relative to the screw shaft in an axial direction thereof. In order to continue the relative linear motion of the nut, it is necessary to circulate the balls rolling along the ball load rolling passageway so that the balls can repeatedly roll along the ball load rolling passageway. However, in the type of ball screw apparatus using a ball circulation tube as a part for circulating the balls, there has been encountered a problem that noises, vibration and others are liable to develop as the speed of revolution of the balls increases.

Therefore, there has been proposed a construction in which a ball return through hole for circulating the balls is formed in the nut, and extends in an axial direction of the screw shaft; and ball turning members, each having a ball turning passageway communicating with both of a ball load rolling passageway and the ball return through hole, are provided at opposite end portions of the nut, respectively (see Japanese Utility Model Examined Publication JP-UM-B-3034052).

In such the ball screw apparatus, the development of noises, vibration and others can be suppressed as compared with the type of ball screw apparatus employing the ball circulation tube. However, when the diameter of the ball return through hole is too large relative to the diameter of the balls, the play of the balls in the ball return through hole (that is, a gap between the ball return through hole and the balls) is large. As a result, the balls are liable to be arranged in a staggered manner in the ball return through hole. In this case, when the screw shaft or the nut is rotated at high speed, the balls in the ball return through hole advances therealong while impinging on the inner surface of the ball return through hole. Accordingly, there is a problem that an acoustic performance is lowered.

### SUMMARY OF THE INVENTION

This invention has been made in view of this problem, and one of objects of the invention is to provide a ball screw apparatus in which a good acoustic performance can be obtained even when the screw shaft or the nut is rotated at high speed.

In order to achieve the above object, according to a first aspect of the present invention, there is provided a ball screw apparatus comprising:

a screw shaft having a first ball screw groove formed on an outer peripheral surface thereof;

a nut including:
a second ball screw groove which is formed on an inner peripheral surface thereof so as to oppose to the first ball screw groove;
a ball return through hole for circulating the balls extended in an axial direction of the screw shaft; and
ball turning members having:
   a ball turning passageway communicating with both of the ball load rolling passageway and the ball return through hole, and provided at opposite end portions of the nut, respectively; and

a number of balls rolling in a ball load rolling passageway, which is formed between the first and second ball screw grooves, in accordance with a rotation of the screw shaft or the nut,

wherein

when a diameter of the balls is represented by Dw, and a diameter of the ball return through hole is represented by D₁, D₁−Dw is 3% of Dw or more and 10% of Dw or less.

According to a second aspect of the present invention, as set forth in the first aspect of the present invention, it is preferable that the ball screw apparatus according to claim 1, wherein when a diameter of the ball turning passageway is represented by D₂, D₂−Dw is 10% of Dw or less.

According to a third aspect of the present invention, as set forth in the first aspect of the present invention, it is preferable that a spacer made of material which is softer than that of the balls is provided between any two adjacent balls.

According to a fourth aspect of the present invention, as set forth in the third aspect of the present invention, it is preferable that each of the spacers is formed into a disk-like shape, and is smaller in diameter than the balls.

According to a fifth aspect of the present invention, as set forth in the third aspect of the present invention, it is preferable that each of the spacers is formed into a spherical shape, and is smaller in diameter than the balls.

According to a sixth aspect of the present invention, as set forth in the second aspect of the present invention, it is preferable that a spacer made of material which is softer than that of the balls is provided between any two adjacent balls.

According to a seventh aspect of the present invention, as set forth in the sixth aspect of the present invention, it is preferable that each of the spacers is formed into a disk-like shape, and is smaller in diameter than the balls.

According to an eighth aspect of the present invention, as set forth in the sixth aspect of the present invention, it is preferable that each of the spacers is formed into a spherical shape, and is smaller in diameter than the balls.

In the ball screw apparatus of the present invention, when the diameter of the balls is represented by Dw, and the diameter of the ball return through hole is represented by D₁, D₁−Dw is not smaller than 3% of Dw and not larger than 10% of Dw. With this construction, the possibility that the balls are arranged in a stagger manner in the ball return through hole is greatly reduced, therefore a good acoustic performance is obtained even when the screw shaft or the nut is rotated at high speed. And besides, the competing of the balls with each other within the ball return through hole is suppressed, therefore the operability of the ball screw apparatus is enhanced.

### BRIEF DESCRIPTION OF THE DRAWINGS

FIG. 1 is a cross-sectional view of a first embodiment of a ball screw apparatus of the present invention;

FIG. 2 is a perspective view showing a ball turning member shown in FIG. 1;

FIG. 3 is a cross-sectional view showing a spacer shown in FIG. 1;

FIG. 4 is a diagram showing the relation between the amount of gap (defined between balls and a ball return through hole) and an acoustic level of the ball screw; and

FIG. 5 is a cross-sectional view of a second embodiment of a ball screw apparatus of the invention.

### DETAILED DESCRIPTION OF THE PREFERRED EMBODIMENTS

A preferred embodiment of the present invention will now be described with reference to the drawings.

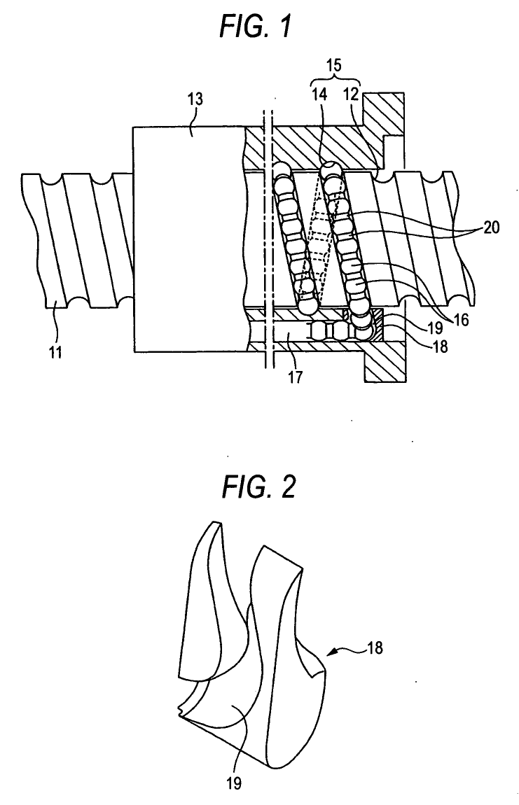

FIG. 1 is a cross-sectional view of a first embodiment of a ball screw apparatus of the invention. In this Figure, reference numeral 11 denotes a screw shaft of the ball screw apparatus of the first embodiment, and a ball screw groove 12 is formed in an outer peripheral surface of the screw shaft 11. Reference numeral 13 denotes a nut having a ball screw groove 14 which is formed in an inner peripheral surface thereof, and is opposed to the ball screw groove 12 of the screw shaft 11. A ball load rolling passageway 15 of a spiral configuration is formed between the ball screw groove 14 of the nut 13 and the ball screw groove 12 of the screw shaft 11. There are provided a number of balls 16 which roll in and along the ball load rolling passageway 15 in accordance with the rotation of the screw shaft 11 or the nut 13.

A ball return through hole 17 for circulating the balls 16 rollingly moving through the ball load rolling passageway 15 is formed in the nut 13, and extends in an axial direction of the screw shaft 11. Ball turning members 18 are incorporated in opposite end portions of the nut 13, respectively. Each of the ball turning members 18 is made of a synthetic resin, and aba turning passageway 19 (see FIG. 2) which communicates with both of the ball load rolling passageway 15 and the ball return through hole 17 is formed in each ball turning member 18.

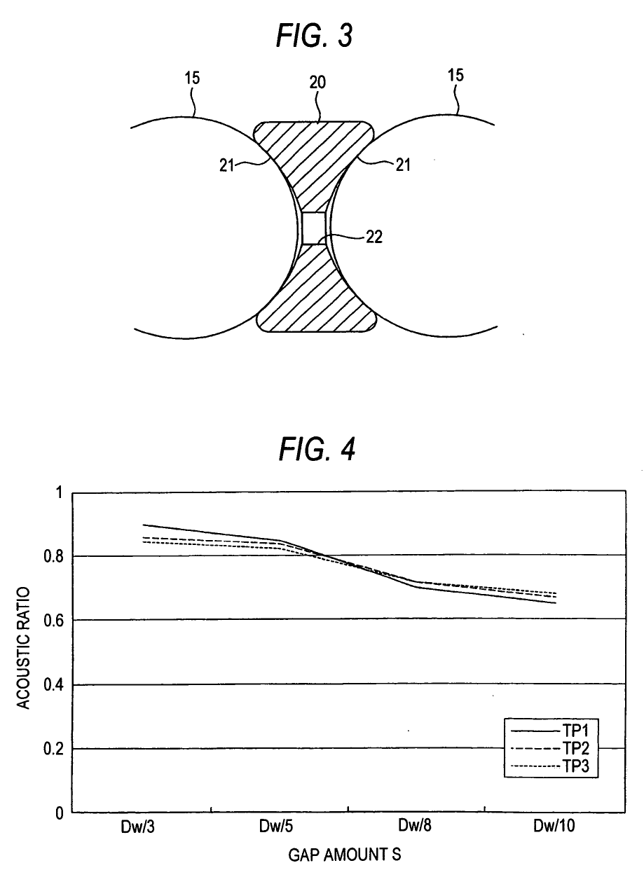

The balls 16 are made, for example, of steel, and a spacer 20 is provided between any two adjacent balls 16. The spacer is made of material (for example, a synthetic resin) which is softer than the material of the balls 16. Each spacer 20 is formed into a disk-like shape, and is smaller in diameter than the ball 16. Concave spherical surfaces 21 (see FIG. 3) are formed in opposite sides of each spacer 20, respectively, and each concave spherical surface 21 has a curvature larger than the diameter of the ball 16. The spacer 20 has a through hole 22 passing through central portions of the two concave spherical surfaces 21 thereof.

The ball return through hole 17 is formed in the nut 13 such that the following formula (1) is satisfied:
(D₁−Dw)≦0.1Dw (1)

where Dw represents the diameter of the ball 16, and D₁ represents the diameter of the ball return through hole 17.

The ball turning passageway 19 is formed in the ball turning member 18 such that the following formula (2) is satisfied:
(D₂−Dw)≦0.1Dw (2)

where Dw represents the diameter of the ball 16, and D₂ represents the diameter of the ball turning passageway 19.

As described above, when the diameter of the ball 16 is represented by Dw, and the diameter of the ball return through hole 17 is represented by D₁, D₁−Dw is not larger than 10% of Dw. With this construction, the play of each ball 16 in the ball return through hole 17 is reduced. As a result, the possibility that the balls 16 are arranged in a stagger manner in the ball return through hole 17 is greatly reduced. Therefore, therefore a good acoustic performance is obtained even when the screw shaft 11 or the nut 13 is rotated at high speed. And besides, the competing of the balls 16 with each other within the ball return through hole 17 is suppressed, and therefore the operability of the ball screw apparatus is enhanced.

Further, in the above embodiment, when the diameter of the ball 16 is represented by Dw, and the diameter of the ball turning passageway 19 is represented by D₂, D₂−Dw is not larger than 10% of Dw. With this construction, the play of each ball 16 in the ball turning passageway 19 is reduced. As a result, the possibility that the balls 16 are arranged in a stagger manner in the ball turning passageway 19 is greatly reduced, and therefore the good acoustic performance is obtained even when the screw shaft 11 or the nut 13 is rotated at high speed. And besides, the competing of the balls 16 with each other within the ball turning passageway 19 is suppressed, and therefore the operability of the ball screw apparatus is enhanced.

Furthermore, in the above embodiment, the spacer 20 (which is made of the material softer than the material of the balls 16) is provided between any two adjacent balls 16, 16, and by doing so, the following ball 16 is prevented from impinging on the ball 16 moving ahead thereof, and therefore the development of noises, vibration and others due to the impingement of the balls on each other is suppressed.

In order to confirm the above effects, the inventor of the present invention carried out an acoustic measurement test for the ball screw apparatus in which a microphone was installed at a level of height spaced upwardly 400 mm from the axis of a screw shaft, and the following test conditions were adopted.

Testing Machine used: Ball Screw Acoustic Measurement Testing Machine manufactured by NSK;

Preload: 1800 N;

Testing Load (Acceleration Load): 1800 N;

Maximum Revolution Number: 3000 min⁻¹;

Stroke: 800 mm;

Lubrication: VG#68 (Idemitsu Kosan);

Testing Ball Screw Apparatus: Ball Screw Number: 40×12×1000−C5 manufactured by NSK:

Results of the test are shown in FIG. 4.

In FIG. 4, the abscissa axis represents the amount S of gaps (=D₁−Dw, D₂−Dw) between the ball return through hole 17 and the balls 16 and also between the ball turning passageway 19 and the balls 16, and the ordinate axis represents an acoustic ratio obtained when the level of a sound pressure, produced when a conventional ball screw apparatus is operated, is expressed as 1. Lines TP1, TP2 and TP3 show results of the acoustic measurement test carried out, using the ball screw apparatus of the above specification.

As shown in FIG. 4, the acoustic ratio much decreases when the gap amount S exceeds Dw/8, and it will be appreciated that when the gap amount S is not larger than Dw/8 and preferably not larger than Dw/10, the decrease of the acoustic ratio is small. Therefore, by setting the amount S of the gap between the ball return through hole 17 and the balls 16 and also between the ball turning passageway 19 and the balls 16 to not larger than Dw/8 and preferably not larger than Dw/10, noises and vibration can be further reduced.

When the gap amount S is smaller than 3% of Dw, the balls 16 are liable to be somewhat caught because of an error in the mounting of the ball turning members 18 in the nut 13, and therefore it is preferred that the gap amount S should be not smaller than 3% of Dw and not larger than 10% of Dw.

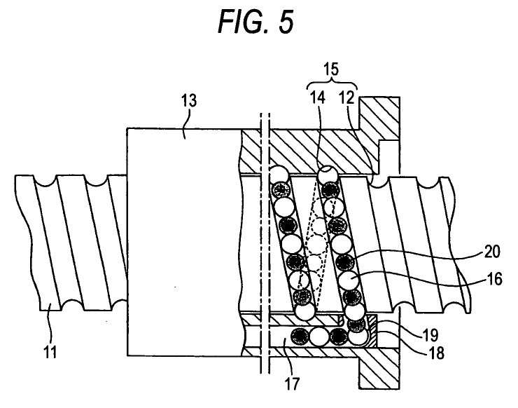

The present invention is not limited to the above embodiment. For example, in the above embodiment, although each of the spacers 20 is formed into a disk-like shape, and is smaller in diameter than the balls 16, there can be used spacers 20 of a spherical shape which are smaller in diameter than the balls 16, as shown in FIG. 5.

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A ball screw apparatus comprising:
a screw shaft having a first ball screw groove formed on an outer peripheral surface thereof;
a nut including:
a second ball screw groove which is formed on an inner peripheral surface thereof so as to oppose to the first ball screw groove;
a ball return through hole for circulating the balls extended in an axial direction of the screw shaft; and
ball turning members having:
a ball turning passageway communicating with both of the ball load rolling passageway and the ball return through hole, and provided at opposite end portions of the nut, respectively; and
a number of balls rolling in a ball load rolling passageway, which is formed between the first and second ball screw grooves, in accordance with a rotation of the screw shaft or the nut,
wherein
when a diameter of the balls is represented by Dw, and a diameter of the ball return through hole is represented by D₁, D₁−Dw is 3% of Dw or more and 10% of Dw or less.

2. The ball screw apparatus according to claim 1, wherein when a diameter of the ball turning passageway is represented by D₂, D₂−Dw is 10% of Dw or less.

3. The ball screw apparatus according to claim 1, wherein a spacer made of material which is softer than that of the balls is provided between any two adjacent balls.

4. The ball screw apparatus according to claim 3, wherein each of the spacers is formed into a disk-like shape, and is smaller in diameter than the balls.

5. The ball screw apparatus according to claim 3, wherein each of the spacers is formed into a spherical shape, and is smaller in diameter than the balls.

6. The ball screw apparatus according to claim 2, wherein a spacer made of material which is softer than that of the balls is provided between any two adjacent balls.

7. The ball screw apparatus according to claim 6, wherein each of the spacers is formed into a disk-like shape, and is smaller in diameter than the balls.

8. The ball screw apparatus according to claim 6, wherein each of the spacers is formed into a spherical shape, and is smaller in diameter than the balls.
